(19) United States
(12) Patent Application Publication
(10) Pub. No.: US 2025/0148492 A1
(43) Pub. Date: May 8, 2025

(54) Consortium Operation Apparatus and Consortium Operation Method

(71) Applicant: Hitachi. Ltd., Chiyoda-ku, Tokyo (JP)

(72) Inventors: Hiroki YAMAMOTO, Tokyo (JP); Koji AMANO, Tokyo (JP); Kyohei NAKA, Tokyo (JP); Shinpei OHYAMA, Tokyo (JP); Kazuma SAWADA, Tokyo (JP); Hiroshi YAMADA, Tokyo (JP)

(21) Appl. No.: 18/832,976

(22) PCT Filed: Aug. 12, 2022
(86) PCT No.: PCT/JP2022/030795

§ 371 Date: Jul. 25, 2024

(30) Foreign Application Priority Data
Mar. 17, 2022 (JP) 2022-042875

(51) Int. Cl. G06Q 30/0207

(52) U.S. Cl. CPC G06Q 30/0207

(57) ABSTRACT

A consortium operation apparatus retains a common database accessible by a terminal used by a business office and a rule for calculating a preferential treatment to be provided to the business office. The common database retains information registered from the terminal, acquires information from the common database in response to a request from the terminal, transmits the information to the terminal to present the information to the business office owning the terminal, aggregates a registration record of information into the common database and a presentation record of information registered in the common database for each terminal, and provides the preferential treatment to each business office based on the aggregated registration record, the aggregated presentation record, and the rule.

### INCORPORATED BY REFERENCE

This application claims priority from Japanese Patent Application No. 2022-42875 filed on Mar. 17, 2022, the subject matter of which is incorporated herein by reference.

### TECHNICAL FIELD

The present invention relates to a consortium operation apparatus and a consortium operation method.

### BACKGROUND ART

JP2002-366643A (PTL 1) is a related art of the present invention. In this publication, it is disclosed that “a service business is performed in which a plurality of companies handling a large number of types of industry and a wide variety of products become members to form a corporate consortium 10, an operation company 11 is established to oversee the companies, and a website is provided online to mediate between a customer 20 and the corporate consortium 10” (see summary).

### CITATION LIST

### Patent Literature

PTL 1: JP2002-366643A

### SUMMARY OF INVENTION

### Technical Problem

In the technique disclosed in PTL 1, a database shared by the companies in the corporate consortium is described, but no method is described for motivating each company to voluntarily register information in the database, and thus useful information may not be registered into the database.

An aspect of the present invention provides an incentive for registering useful information in a database accessible by a plurality of business offices.

### Solution to Problem

In order to solve the above-described problems, one aspect of the present invention adopts the following configuration. A consortium operation apparatus includes: a processor; and a storage apparatus, in which the storage apparatus retains a common database accessible by a terminal used by each of one or more business offices belonging to a consortium and a rule for calculating a preferential treatment to be provided to each of the one or more business offices, the common database retains information registered from the terminal, and the processor acquires information from the common database in response to a request from the terminal, transmits the information to the terminal to present the information to a business office owning the terminal, aggregates a registration record of information into the common database and a presentation record of information registered in the common database for each terminal, and provides the preferential treatment to each of the one or more business offices based on the aggregated registration record, the aggregated presentation record, and the rule.

### Advantageous Effects of Invention

According to one aspect of the present invention, it is possible to provide an incentive for registering useful information in a database accessible by a plurality of business offices.

Problems, configurations, and effects other than those described above will be clarified in description of the following embodiment.

### BRIEF DESCRIPTION OF DRAWINGS

FIG. 1 shows an operation example of a consortium operation system in a first embodiment.

FIG. 2 is a block diagram showing a configuration example of an individual information management apparatus in the first embodiment.

FIG. 3 is a block diagram showing a configuration example of a common information management apparatus in the first embodiment.

FIG. 4 is an example of a common dictionary DB in the first embodiment.

FIG. 5 is an example of a common structured ID DB in the first embodiment.

FIG. 6 is an example of a common relationship link DB in the first embodiment.

FIG. 7 is an example of a membership management DB in the first embodiment.

FIG. 8 shows an outline example of cooperation between the individual information management apparatus and each apparatus in the first embodiment.

FIG. 9 is a sequence diagram showing an example of a consortium participation registration phase and an individual DB use and registration phase in the first embodiment.

FIG. 10 shows an outline example of push-type individual DB use processing and individual DB registration processing in the first embodiment.

FIG. 11 is a sequence diagram showing an example of a common DB use phase in the first embodiment.

FIG. 12 is a sequence diagram showing an example of a common DB registration phase in the first embodiment.

FIG. 13 is an example of a membership fee calculation rule in the first embodiment.

FIG. 14A is an example of a graph showing a relationship between a rank and a membership fee reduction rate X in the first embodiment.

FIG. 14B shows an example of a graph showing a relationship between the rank and an actual membership fee R in the first embodiment.

### DESCRIPTION OF EMBODIMENTS

Hereinafter, an embodiment of the present invention will be described in detail with reference to the drawings. In the present embodiment, the same components are denoted by the same reference numerals in principle, and repeated description thereof is omitted. It should be noted that the present embodiment is merely an example for implementing the present invention and does not limit the technical scope of the present invention.

### First Embodiment

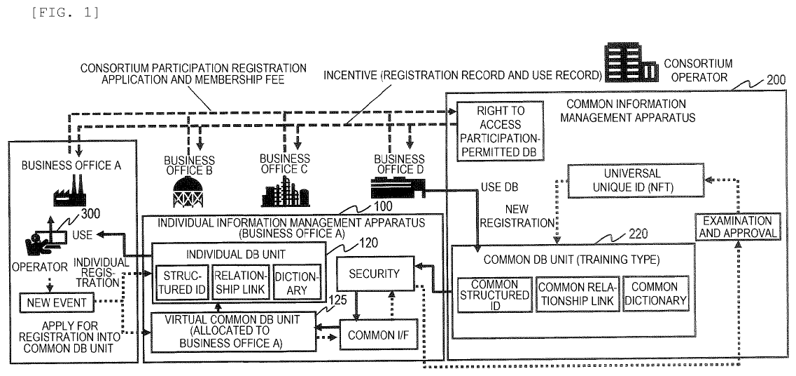

FIG. 1 shows an operation example of a consortium operation system. The consortium operation system includes an individual information management apparatus 100 owned by a respective business office participating in a consortium and a common information management apparatus 200 owned by a consortium operator. The common information management apparatus 200 is connected to each individual information management apparatus 100 via a network such as the Internet.

In the example in FIG. 1, an example is shown in which a plurality of business offices (business offices A to D) participate in the consortium, and alternatively, the number of business offices participating in the consortium may be one. In FIG. 1, for ease of viewing, individual information management apparatuses 100 owned by the business office B, the business office C, and the business office D are not shown.

The individual information management apparatus 100 is connected to a terminal 300 of each of one or more departments under the respective business office. The individual information management apparatus 100 includes an individual database (DB) unit 120 and a virtual common DB unit 125. The common information management apparatus 200 includes a common DB unit 220. The individual information management apparatuses 100 are not connected to each other, and the business office owning the individual information management apparatus 100 can acquire information in the individual DB unit 120 and the virtual common DB unit 125 of the individual information management apparatus 100 owned by the same business office and information in the common DB unit 220 of the common information management apparatus 200, but cannot directly acquire information in the individual DB unit 120 and the virtual common DB unit 125 of the individual information management apparatus 100 owned by another business office.

The business office is permitted to participate in the consortium by applying for a participation registration into the consortium. When the business office permitted to participate in the consortium pays a membership fee (for example, a monthly membership fee or an annual membership fee) to the consortium operator, the individual information management apparatus 100 owned by each business office is granted a right to access the common DB unit 220 of the common information management apparatus 200.

The individual information management apparatus 100 receives a request to newly register, in the individual DB unit 120, an event input into the terminal 300 by an operator or an event observed by a predetermined application, for example, from the terminal 300 or the application. Predictive diagnosis information of an abnormality in target equipment owned by the business office, maintenance information obtained by observing the target equipment with an observation apparatus, management information about management of the target equipment, and the like are all examples of the event. The event may include, for example, a file of a manual or a drawing to be referred to when the target equipment fails.

The individual information management apparatus 100 generates a structured ID (a unique name attached to information representing the event in a format that can be understood by a computer) for the event requested to be registered into the individual DB unit 120, and registers the structured ID in the individual thereby converting each piece of information into data that can be individually identified.

The individual information management apparatus 100 registers, in the individual DB unit 120, a relationship link that is a link associating structured IDs that are constituent elements related to each other, the relationship link being a constituent element that may be contained in each structured ID registered in the individual DB unit 120. The individual information management apparatus 100 may generate and register the relationship link by extracting a relationship between the registered structured IDs, or may register the relationship link specified by a user of the terminal 300.

The terminal 300 receives a request to register, in the common DB unit 220, an event input to the terminal 300 by the operator or an event observed by a predetermined application from the terminal 300 or the application.

The individual information management apparatus 100 generates a structured ID for each event requested to be registered into the common DB unit 220. The individual information management apparatus 100 generates a relationship link by extracting a relationship between generated structured IDs, or acquires a relationship link specified by the user of the terminal 300 and requested to be registered into the common DB unit 220.

The individual information management apparatus 100 uses a dictionary stored in the individual DB unit 120 to convert a term (for example, a term other than a general term) specific to the business office, which is contained in the structured ID and the relationship link to be registered into the common DB unit 220, into the general term and registers the general term in the virtual common DB unit 125. The individual information management apparatus 100 may also register the structured ID and the relationship link to be registered into the common DB unit 220 in the individual DB unit 120.

The individual information management apparatus 100 transmits the structured ID and the relationship link after the conversion to the common information management apparatus 200 via an interface to the common information management apparatus 200. The individual information management apparatus 100 may transmit the structured ID and the relationship link after the conversion to the common information management apparatus 200 only when it is determined that there is no concern in terms of security in the registration of the structured ID and the relationship link after the conversion into the common DB unit 220 (for example, no secret information of the business office is contained in the structured ID the relationship link after the conversion).

The individual information management apparatus 100 may receive a request to register, in the common DB unit 220, the structured ID and the relationship link registered in the individual DB unit 120, for example, according to input from the operator of the terminal 300. In this case, the individual information management apparatus 100 uses the dictionary stored in the individual DB unit 120 to convert a term specific to the business office contained in the structured ID and the relationship link to be registered in the common DB unit 220 into the general term, registers the general term in the virtual common DB unit 125, and transmits the structured ID and the relationship link after the conversion to the common information management apparatus 200 via the interface to the common information management apparatus 200.

The individual information management apparatus 100 may transmit the business-office-specific term contained in the structured ID and the relationship link to the common information management apparatus 200 without conversion, and the common information management apparatus 200 may convert the business-office-specific term into the general term using a common dictionary to be described later.

The individual information management apparatus 100 may omit the processing of registering, in the virtual common DB unit 125, the structured ID and the relationship link to be registered into the common DB unit 220, and transmit the structured ID and the relationship link to the common information management apparatus 200. In this case, the individual information management apparatus 100 may not retain the virtual common DB unit 125.

The common information management apparatus 200 examines whether to register, in the common DB unit 220, the structured ID and the relationship link to be registered into the common DB unit 220. When the examination of the registration of the structured ID and the relationship link indicates denial, the common information management apparatus 200 notifies the individual information management apparatus 100 that the examination result indicates denial without registering the structured ID and the relationship link in the common DB unit 220. The individual information management apparatus 100 that receives the notification may delete the structured ID and the relationship link from the virtual common DB unit 125.

When the registration examination of the structured ID and the relationship link indicates approval, the common information management apparatus 200 assigns a universal unique ID (hereinafter also referred to as a UUID) for uniquely identifying information (structured ID and relationship link) in the common DB unit 220, registers the structured ID and the relationship link as a common structured ID and a common relationship link, respectively, in the common DB unit 220, and notifies the individual information management apparatus 100 that the examination result indicates approval. The common information management apparatus 200 may ensure uniqueness of the UUID by using predetermined encryption processing such as a non-fungible token (NFT) or a blockchain.

The common information management apparatus 200 may define a relationship link between common structured IDs registered in the common DB unit 220, which are common structured IDs registered from individual information management apparatuses 100 owned by different business offices, and register the defined relationship link in the common DB unit 220.

Upon receiving a common DB use request from the individual information management apparatus 100, the common information management apparatus 200 acquires, from the common DB unit 220, the common structured ID and the common relationship link corresponding to information indicated by the common DB use request. The common DB use request from the individual information management apparatus 100 includes, for example, a constituent element of an event input into the terminal 300 by the user or observed by an application connected to the individual information management apparatus 100.

The common information management apparatus 200 converts, using the common dictionary (a dictionary for converting the general term into the business-office-specific term of each business office), the general term contained in the acquired common structured ID and the acquired common relationship link into a term of the business office owning the individual information management apparatus 100 that transmits the common DB use request, and transmits the converted information to the individual information management apparatus 100. The common information management apparatus 200 may transmit the general term contained in the acquired information to the individual information management apparatus 100 without conversion, and the individual information management apparatus 100 may convert the general term into the business-office-specific term using a dictionary of the individual information management apparatus 100.

When it is determined that there is a security concern with the received information (for example, when it is determined based on NFT that the received information is tampered with, or when a virus, impersonation, or hacking is detected), the individual information management apparatus 100 that receives the information in the common DB unit 220 may discard the received information without displaying, or may temporarily store the received information in a log and output an alert to the common information management apparatus 200. When the alert is output, for example, the consortium operator checks a communication path between the common information management apparatus 200 and the individual information management apparatus 100 and implements a measure, and determines whether the information is to be discarded or displayed based on results of the check and the measure. The common information management apparatus 200 transmits the determination result input from the consortium operator to the individual information management apparatus 100, and the individual information management apparatus 100 executes processing on the information temporarily stored in the log according to the determination result.

The common information management apparatus 200 manages, for each business office, a registration record of information into the common DB unit 220 (for example, a registration record of the common structured ID and/or the common relationship link) and a use record of information registered in the common DB unit 220 (for example, a citation record of the common structured ID and/or a common relationship link by another business office). The common information management apparatus 200 provides a preferential treatment to the business office based on the registration record and the use record for each business office. Reduction in the membership fee or provision of money is an example of the preferential treatment. Another example of the preferential treatment is disclosure of an increase in a status of the business office in a community operated by the consortium. The disclosure of the increase in the status of the business office leads to improvement in a social value of the business office. Hereinafter, it is assumed that the membership fee is reduced as the preferential treatment.

The common information management apparatus 200 can motivate the business office to register a large amount of useful information in the common DB unit 220 by providing the preferential treatment to the business office based on the registration record and the citation record, and further, the business office can also acquire useful information from the common DB unit 220.

The individual information management apparatus 100 may request the common information management apparatus 200 to transmit the information (for example, the common structured ID, the common relationship link, and the common dictionary) in the common DB unit 220 periodically, for example. In this case, the individual information management apparatus 100 may store the received information in the virtual common DB unit 125.

It is desirable that the individual information management apparatus 100 can freely delete information registered in the individual DB unit 120 and the virtual common DB unit 125 of the same individual information management apparatus 100.

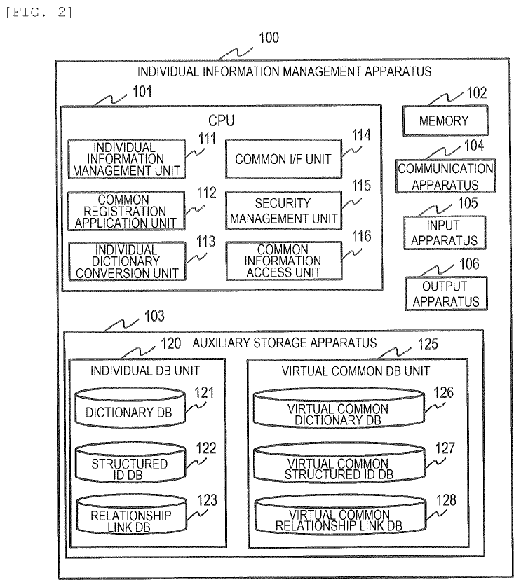

FIG. 2 is a block diagram showing a configuration example of the individual information management apparatus 100. The individual information management apparatus 100 includes, for example, a computer including a central processing unit (CPU) 101, a memory 102, an auxiliary storage apparatus 103, a communication apparatus 104, an input apparatus 105, and an output apparatus 106.

The CPU 101 includes a processor and executes a program stored in the memory 102. The memory 102 includes a read only memory (ROM) that is a non-volatile storage element and a random access memory (RAM) that is a volatile storage element. The ROM stores an immutable program (for example, a basic input/output system (BIOS)) and the like. The RAM is a high-speed volatile storage element such as a dynamic random access memory (DRAM), and temporarily stores a program executed by the CPU 101 and data used when the program is executed.

The auxiliary storage apparatus 103 is a large-capacity non-volatile storage apparatus such as a magnetic storage apparatus (hard disk drive (HDD)) and a flash memory (solid state drive (SSD)), and stores a program executed by the CPU 101 and data used when the program is executed. That is, the program is read from the auxiliary storage apparatus 103, loaded into the memory 102, and executed by the CPU 101.

The input apparatus 105 is an apparatus that receives input from an operator, such as a keyboard or a mouse. The output apparatus 106 is an apparatus that outputs an execution result of a program in a format that can be visually recognized by the operator, such as a display apparatus or a printer.

The communication apparatus 104 is a network interface apparatus that controls communication with another apparatus according to a predetermined protocol. The communication apparatus 104 includes, for example, a serial interface such as a universal serial bus (USB).

A part or all of programs executed by the CPU 101 may be provided via a network to the individual information management apparatus 100 from a removable medium (a CD-ROM, a flash memory, or the like) that is a non-transitory storage medium or an external computer including a non-transitory storage apparatus, and may be stored in the non-volatile auxiliary storage apparatus 103 that is a non-transitory storage medium. Therefore, the individual information management apparatus 100 may include an interface for reading data from the removable medium. The same applies to the common information management apparatus 200.

The individual information management apparatus 100 is a computer system implemented on one physical computer or a plurality of computers implemented logically or physically, and may operate in separate threads on the same computer or on a virtual computer built on a plurality of physical computer resources. The same applies to the common information management apparatus 200.

The CPU 101 includes, for example, an individual information management unit 111, a common registration application unit 112, an individual dictionary conversion unit 113, a common interface (I/F) unit 114, a security management unit 115, and a common information access unit 116.

The individual information management unit 111 registers information in the individual DB unit 120 and acquires the information registered in the individual DB unit 120. The common registration application unit 112 applies to the common information management apparatus 200 for participation in the consortium of the individual information management apparatus 100. The individual dictionary conversion unit 113 converts the business-office-specific term contained in information registered in each DB unit or information acquired from each DB unit into the general term or converts the general term into the business-office-specific term.

The common I/F unit 114 functions as an interface for transmitting and receiving information between the individual information management apparatus 100 and the common information management apparatus 200. The security management unit 115 manages security of information exchange between the individual information management apparatus 100 and the common information management apparatus 200. The common information access unit 116 requests a registration of information into the common DB unit 220 and acquires the information registered in the common DB unit 220 via the common I/F unit 114, registers information in the virtual common DB unit 125, and acquires the information registered in the virtual common DB unit 125.

For example, the CPU 101 functions as the individual information management unit 111 by operating according to an individual information management program loaded into the memory 102, and functions as the common registration application unit 112 by operating according to a common registration application program loaded into the memory 102. For other functional units in the CPU 101, a relationship between programs and the functional units is the same. For functional units to be described later in a CPU 201 to be described later of the common information management apparatus 200 as well, a relationship between programs and the function units is the same.

A part or all of functions of the functional units in the CPU 101 and the CPU 201 may be implemented by hardware such as an application specific integrated circuit (ASIC) or a field-programmable gate array (FPGA).

The auxiliary storage apparatus 103 includes, for example, the individual DB unit 120 and the virtual common DB unit 125 that are areas for storing data. The individual DB unit 120 retains, for example, a dictionary DB 121, a structured ID DB 122, and a relationship link DB 123.

The dictionary DB 121 retains information indicating correspondence between the term specific to the business office owning the individual information management apparatus 100 and the general term. The structured ID DB 122 retains the structured ID generated by the individual information management apparatus 100. The relationship link DB 123 retains the relationship link generated by the individual information management apparatus 100.

The virtual common DB unit 125 retains, for example, a virtual common dictionary DB 126, a virtual common structured ID DB 127, and a virtual common relationship link DB 128. The virtual common dictionary DB 126 retains information indicating the correspondence between the term specific to each business office and the general term. The virtual common structured ID DB 127 retains the structured ID registered in the common DB unit 220 from the individual information management apparatus 100 or the structured ID received from the common information management apparatus 200. The virtual common relationship link DB 128 retains the relationship link registered in the common DB unit 220 from the individual information management apparatus 100 or the relationship link received from the common information management apparatus 200.

A part or all of information stored in the auxiliary storage apparatus 103 and an auxiliary storage apparatus 203 to be described later of the common information i management apparatus 200 may be stored in the memory 102 and a memory 202 to be described later of the common information management apparatus 200, or may be stored in another database connected to the respective apparatuses.

In the present embodiment, information used by the consortium operation system may be expressed by any data structure without depending on the data structure. Although the information is expressed in a table format in the present embodiment, for example, a data structure appropriately selected from a list, a database, or a queue can store the information.

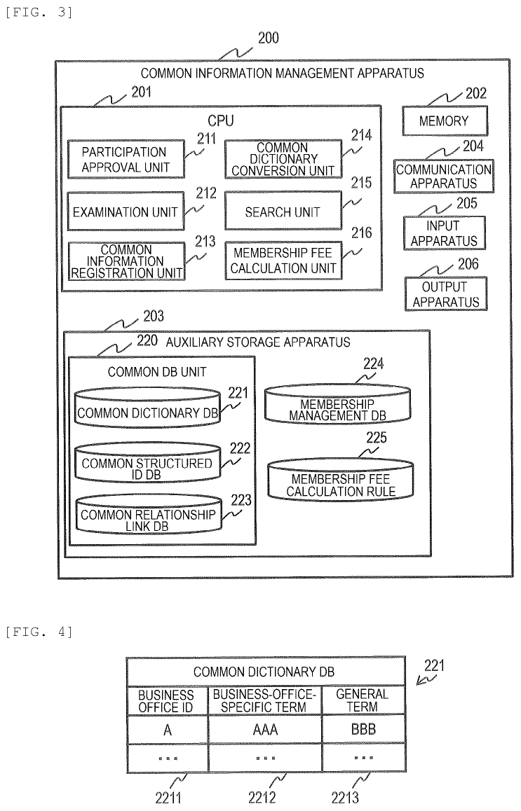

FIG. 3 is a block diagram showing a configuration example of the common information management apparatus 200. The common information management apparatus 200 includes, for example, a computer including the CPU 201, the memory 202, the auxiliary storage apparatus 203, a communication apparatus 204, an input apparatus 205, an output apparatus 206, and a biometric information acquisition apparatus 207.

Since description of hardware of the CPU 201, the memory 202, the auxiliary storage apparatus 203, the communication apparatus 204, the input apparatus 205, and the output apparatus 206 is the same as description of the hardware of the CPU 101, the memory 102, the auxiliary storage apparatus 103, the communication apparatus 104, the input apparatus 105, and the output apparatus 106, the description is omitted.

The CPU 201 includes, for example, a participation approval unit 211, an examination unit 212, a common information registration unit 213, a common dictionary conversion unit 214, a search unit 215, and a membership fee calculation unit 216. The participation approval unit 211 determines whether the individual information management apparatus 100 that applies for a participation registration into the consortium is approved for participation in the consortium. The examination unit 212 examines whether to register information received from the individual information management apparatus 100 in the common DB unit 220. The common information registration unit 213 registers, in the common DB unit 220, information received from the individual information management apparatus 100 and approved by the examination unit.

The common dictionary conversion unit 214 converts the business-office-specific term contained in information registered in each DB unit or information acquired from each DB unit into the general term or converts the general term into the business-office-specific term. The search unit 215 searches the common DB unit 220 in response to the common DB use request from the individual information management apparatus 100, and transmits a search result to the individual information management apparatus 100. The membership fee calculation unit 216 calculates the membership fee to be paid to the consortium operator by each business office.

The auxiliary storage apparatus 203 includes, for example, the common DB unit 220 that is an area for storing data. The common DB unit 220 retains, for example, a common dictionary DB 221, a common structured ID DB 222, and a common relationship link DB 223.

The common dictionary DB 221 retains information indicating the correspondence between the term specific to each business office and the general term. The common structured ID DB 222 retains the structured ID received from each individual information management apparatus 100 and approved by the examination unit 212. The common relationship link DB 223 retains the relationship link received from each individual information management apparatuses 100 and approved by the examination unit 212.

The auxiliary storage apparatus 203 retains, for example, a membership management DB 224 and a membership fee calculation rule 225. The membership management DB 224 retains information indicating the membership fee to be paid to the consortium operator by each business office. The membership fee calculation rule 225 is a rule for calculating the membership fee to be paid to the consortium operator by each business office.

In the present embodiment, the individual information management apparatus 100 and the common information management apparatus 200 are shown as separate apparatuses, and alternatively, the individual information management apparatus 100 and the common information management apparatus 200 may be integrated. When the individual information management apparatus 100 and the common information management apparatus 200 are integrated, the individual DB unit 120 and the virtual common DB unit 125 are prepared for each business office, and the terminal 300 owned by each business office has a right to access the individual DB unit 120 and the virtual common DB unit 125 prepared for the business office.

FIG. 4 is an example of the common dictionary DB 221. The common dictionary DB 221 retains, for example, a business office ID field 2211, a business-office-specific term field 2212, and a general term field 2213. The business office ID field 2211 retains a business office ID for uniquely identifying the business office. The business-office-specific term field 2212 indicates a term used in the business office indicated by the business office ID. The general term field 2213 indicates the general term synonymous with the business-office-specific term used in the business office indicated by the business office ID.

The virtual common dictionary DB 126 has a table structure similar to that of the common dictionary DB 221, a table structure of the dictionary DB 121 is obtained by deleting the business office ID field 2211 from the common dictionary DB 221 (the business office ID field 2211 may be provided), and thus illustration thereof is omitted.

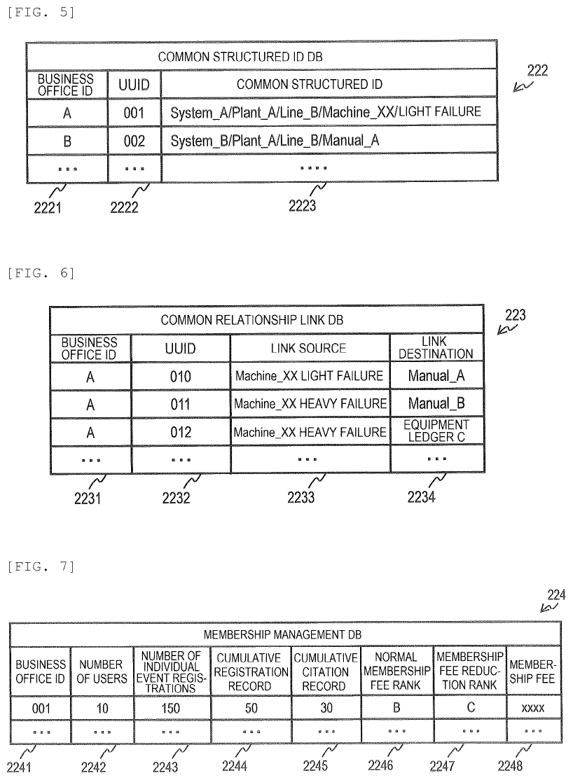

FIG. 5 is an example of the common structured ID DB 222. The common structured ID DB 222 includes, for example, a business office ID field 2221, a UUID field 2222, and a common structured ID field 2223. The business office ID field 2221 retains the business office ID. The UUID field 2222 retains the UUID assigned to the common structured ID.

The common structured ID field 2223 retains the common structured ID. The common structured ID separates, by slashes or the like, connections between constituent elements constituting an event acquired by the individual information management apparatus 100 (for example, an element located on a right side of a slash is an element contained in an element located on a left side of the slash, an event occurring in the element located on the left side, or a material related to the element located on the left side) and thus hierarchically defines the event. The common structured ID is an ID assigned to information or data indicated by the event and formed by a character string which can be distinguished by the computer, and uniqueness of the information or data is secured by the common structured ID.

For example, a structured ID “System_A/Plant_A/Line_B/Machine_XX/light failure” in FIG. 5 indicates a light failure (occurring) in a Machine_XX (provided) in a Line_B (provided) in a Plant_A (provided) in a System_A. For example, “System_B/Plant_A/Line_B/Manual_A” shown in FIG. 4 indicates a Manual_A in a Line_B (provided) in a Plant_A (provided) in a System_B.

The virtual common structured ID DB 127 has a table structure similar to that of the common structured ID DB 222, a table structure of the structured ID DB 122 is obtained by deleting the business office ID field 2221 and the UUID field 2222 from the common structured ID DB 222 (the business office ID field 2221 and the UUID field 2222 may be provided) and providing a structured ID field where the structured ID registered in the individual information management apparatus 100 is stored instead of the common structured ID field 2223, and thus illustration thereof is omitted.

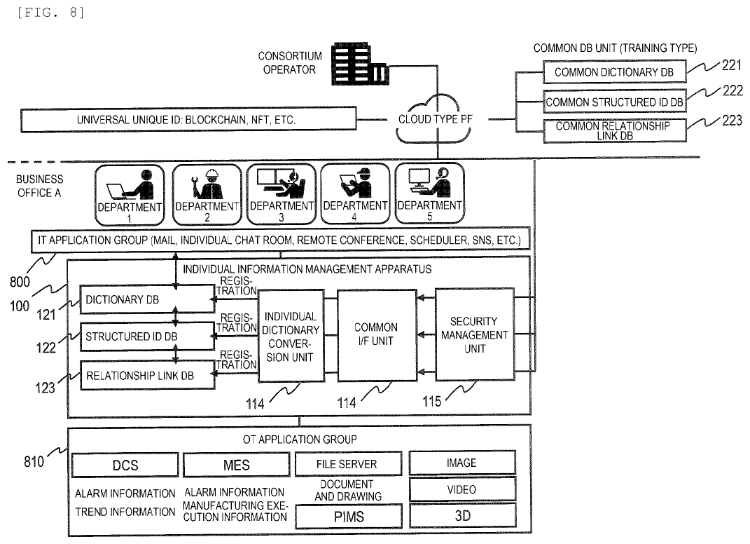

FIG. 6 is an example of the common relationship link DB 223. The common relationship link DB 223 includes, for example, a business office ID field 2231, a UUID field 2232, a link source field 2233, and a link destination field 2234. The business office ID field 2231 retains the business office ID of the business office whose corresponding relationship link is registered in the common relationship link DB 223. The UUID field 2232 retains the UUID assigned to the common relationship link. The link source field 2233 and the link destination field 2234 define the common relationship link, and show related configurations contained in the common structured ID.

The common structured ID DB 222 in FIG. 5 includes the common structured ID “System_A/Plant_A/Line_B/Machine_XX/light failure” and the common structured ID “System_B/Plant_A/Line_B/Manual_A”, which indicate that a series of constituent elements “Plant_A/Line_B/” partially match across such common structured IDs.

In the common relationship link DB 223 in FIG. 6, a series of constituent elements “Machine_XX” and “light failure” and a constituent element “Manual_A”, which are connected after the partially matched constituent elements, are connected by the relationship link. Due to the relationship link, when “light failure” occurs in “Machine_XX”, it is presumed that it is useful to refer to “Manual_A”.

The relationship link may be defined by know-how of the business office or the consortium operator. Specifically, for example, knowledge that an event “B” is likely to occur when an event “A” occurs based on know-how from past entrepreneurship, and experience that a manual “C” is to be referred to when the event “A” occurs may be stored in association with the link source field 2233 and the link destination field 2234, respectively.

In the common relationship link DB 223 in FIG. 6, the link source and the link destination of the relationship link are defined, and alternatively, a direction may not be defined in the relationship link (the link is not from the link source to the link destination).

The virtual common relationship link DB 128 has a table structure similar to that of the common relationship link DB 223, and a table structure of the relationship link ID DB 123 is obtained by deleting the business office ID field 2231 and the UUID field 2232 from the common relationship link DB 223 (the business office ID field 2221 may be provided) and defining the relationship link registered in the individual information management apparatus 100 in the link source field 2233 and the link destination field 2234, and thus illustration thereof is omitted.

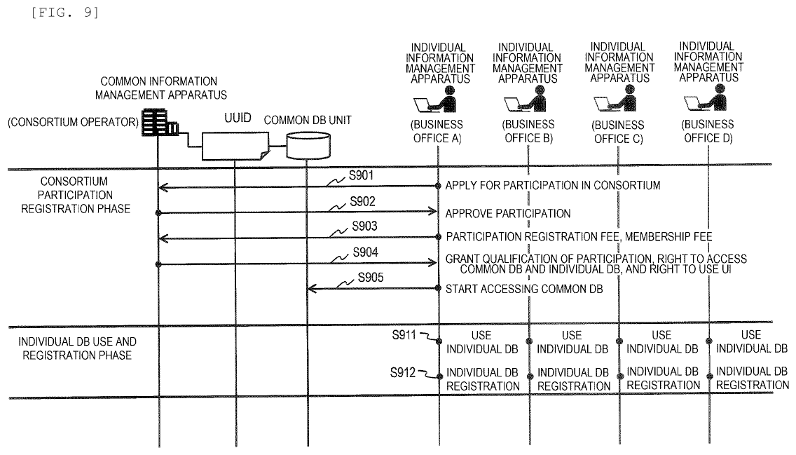

FIG. 7 is an example of the membership management DB 224. The membership management DB 224 includes, for example, a business office ID field 2241, a number-of-users field 2242, a number-of-individual-event-registrations field 2243, a cumulative registration record field 2244, a cumulative citation record field 2245, a normal membership fee rank field 2246, a membership fee reduction rank field 2247, and a membership fee field 2248.

The business office ID field 2241 retains the business office ID. The number-of-users field 2242 indicates the number of users of the consortium operation system in the business office. The number-of-individual-event-registrations field 2243 indicates the number of events (for example, the number of structured IDs and/or relationship links) registered in the individual DB unit 120 of the individual information management apparatus 100.

The cumulative registration record field 2244 indicates the cumulative number of pieces of information (for example, the number of common structured IDs and/or common relationship links) registered in the common DB unit 220 from the individual information management apparatus 100. The cumulative citation record field 2245 indicates the number of pieces of information (common structured IDs and/or common relationship links) cited from the common DB unit 220 by another individual information management apparatus 100 among information (common structured IDs and/or common relationship links) registered in the common DB unit 220 from the individual information management apparatus 100.

The normal membership fee rank field 2246 retains information indicating a normal membership fee rank that is a rank for determining a normal membership fee (a membership fee before reduction), which is calculated by the membership fee calculation unit 216 based on the membership fee calculation rule 225, the number of users of the business office, and the number of individual event registrations of the individual information management apparatus 100. The membership fee reduction rank field 2247 retains information indicating a membership fee reduction rank that is a rank for determining a membership fee reduction rate, which is calculated by the membership fee calculation unit 216 based on the membership fee calculation rule 225, a cumulative registration record of the individual information management apparatus 100, and the number of individual event registrations of the individual information management apparatus 100. The membership fee field 2248 indicates a membership fee to be paid by the business office, which is calculated by the membership fee calculation unit 216 based on the membership fee calculation rule 225, the normal membership fee rank, and the membership fee reduction rank.

FIG. 8 shows an outline example of cooperation between the individual information management apparatus 100 and each apparatus. In FIG. 8, for convenience of description, a part of the configuration of the individual information management apparatus 100 and a part of the configuration of the common information management apparatus 200 are not shown. FIG. 8 shows the individual information management apparatus 100 of the business office A.

As described above with reference to FIG. 1, the individual information management apparatus 100 performs information registration and information use relative to the common information management apparatus 200 via a network such as the Internet. That is, the common dictionary DB 221, the common structured ID DB 222, and the common relationship link DB 223 in the common DB unit 220 are implemented on, for example, a cloud type platform (PF) provided by the common information management apparatus 200.

The business office A includes, for example, a plurality of departments (departments 1 to 5), and the terminal 300 owned by each department can include an information technology (IT) application group 800 and can execute such applications.

The applications in the IT application group 800 can transmit and receive information to and from the individual information management apparatus 100. The individual information management apparatus 100 can receive, for example, mail information, individual chat room information, remote conference information, scheduler information, and social networking service (SNS) information from an application in the IT application group 800.

For example, the individual dictionary conversion unit 113 stores information in the dictionary DB 114 by receiving information input from the terminal 300 to an application in the IT application 800 and automatically learning correspondence information between the business-office-specific term and the general term contained in the information.

For example, the individual information management apparatus 100 may receive information input from the terminal 300 to an application in the IT application group 800, automatically learn the structured ID and the relationship link from an event indicated by the information, and store the information in the structured ID DB 122 and the relationship link DB 123.

In particular, for example, since an individual chat room provided by the IT application group 800 is a chat room closed within a department, chat contents are not shared with other departments. However, as described above, since the individual information management apparatus 100 automatically learns correspondence between the business-office-specific term and the general term, the structured ID, and the relationship link from information in the individual chat room, it is possible to store information about each department in the dictionary DB 121, the structured ID DB 122, and the relationship link DB 123 without disclosing the chat contents to the other departments.

Applications in an operational technology (OT) application group 810 can transmit and receive information to and from the individual information management apparatus 100. The individual information management apparatus 100 can receive, from the applications in the OT application group 810, for example, alarm information and trend information of target equipment in the business office A that provides a distribute control system (DCS), alarm information of the target equipment and manufacturing execution information of the target equipment provided by a manufacturing execution system (MES), a document and a drawing related to the target equipment retained by a file server, operation information of the target equipment provided by a plant information management system (PIMS), and a video, an image, and a 3D image of the target equipment or a product manufactured by the target equipment.

The individual information management apparatus 100 may receive information from an application in the OT application group 810, automatically learn the structured ID and the relationship link from an event indicated by the information, and store the information in the structured ID DB 122 and the relationship link DB 123.

Processing of a consortium participation registration phase, an individual DB use and registration phase, a common DB use phase, and a common DB registration phase will be described, and a part of description for processing described using FIG. 1 may be omitted.

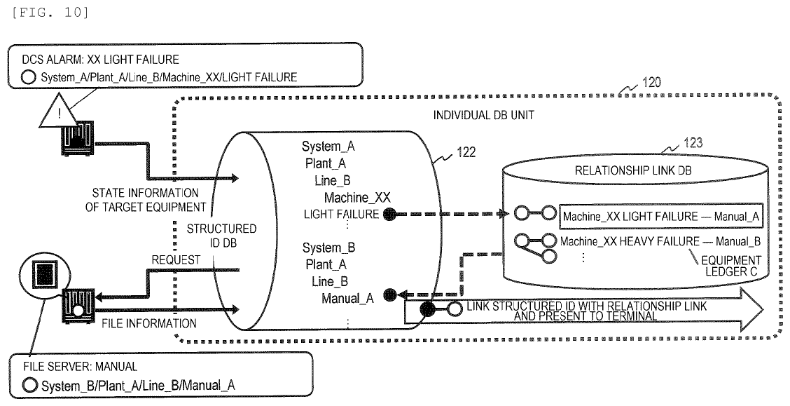

FIG. 9 is a sequence diagram showing an example of the consortium participation registration phase and the individual DB use and registration phase. First, processing of the consortium participation registration phase will be described. In the example in FIG. 9, processing for the business office A to register participation in the consortium will be described, and since the same processing is executed for other business offices, illustration and description thereof will be omitted.

The common registration application unit 112 of the individual information management apparatus 100 transmits, to the common information management apparatus 200, an application for participation in the consortium (S901). The participation approval unit 211 of the common information management apparatus 200 determines whether the business office A is approved for participation according to, for example, input of a user of the common information management apparatus 200, and returns a participation approval notification to the individual information management apparatus 100 when the participation is approved (S902). When the participation of the business office A is rejected, the participation approval unit 211 of the common information management apparatus 200 returns a participation rejection notification to the individual information management apparatus 100, and the consortium participation registration phase ends.

When the individual information management apparatus 100 receives the participation approval notification, the common registration application unit 112 notifies the common information management apparatus 200 of the number of users of the business office A that can access the common DB unit 220 according to input from a user of the business office A. The membership fee calculation unit 216 notifies the individual information management apparatus 100 of a participation registration fee and the membership fee (for example, an annual membership fee periodically occurring in a period in which participation in the consortium is registered) for registration of participation in the consortium, and the business office A pays the participation registration fee and the membership fee to the consortium operator (S903). The participation registration fee is, for example, a predetermined amount of money, and is calculated by the membership fee calculation unit 216 according to the membership fee calculation rule 225 to be described later.

When payment of the participation registration fee and the membership fee is confirmed, the participation approval unit 211 generates the business office ID of the business office A, transmits the business office ID to the individual information management apparatus 100, and grants, to the individual information management apparatus 100 of the business office A, qualification of participation in the consortium, a right to access the individual DB unit 120 of the individual information management apparatus 100 of the business office A, a right to access the common DB unit 220, and a right to access a user interface (UI) output from the common information management apparatus 200 to the terminal 300 (S904).

The UI displays, for example, log-in information of a user who logs in to the common DB unit 220, information about an event (for example, a failure) occurring in the target equipment, information about a past case associated with the event by the common relationship link and a manual of the target equipment (information provided by a push-type to be described later or information obtained by a pull-type by the user of the business office who searches for the past case associated by the common relationship link), and observation information indicating a state of the target equipment.

A registration screen (for example, a screen for registering correspondence between the business-office-specific term and the general term) to the common dictionary DB 221 may be displayed on the UI.

Although not shown, it is desirable that the common information management apparatus 200 retains a DB for managing the business office (individual information management apparatus 100) to which each of the qualification of participation in the consortium, the right to access the individual DB unit 120 of the individual information management apparatus 100 of the business office A, the right to access the common DB unit 220, and the right to access the user interface (UI) is granted.

When the right to access the common DB unit 220 is acquired, the common information access unit 116 can access the common DB unit 220 via the common I/F unit 114 (S905), that is, can refer to information in the common DB unit 220 or register information into the common DB unit 220.

If the individual information management apparatus 100 completes the processing of the consortium participation registration phase, the individual information management apparatus 100 can execute all of the processing of the individual DB use and registration phase, the common DB use phase to be described later, and the common DB registration phase to be described later.

Next, processing of an individual DB use phase will be described. The individual information management unit 111 acquires information stored in the individual DB unit 120 in response to, for example, a DB use request from the terminal 300 (an individual DB use request input by the user of the terminal 300), and displays the acquired information on the output apparatus 106 or the terminal 300 (S911).

Specifically, for example, the individual DB use request from the terminal 300 includes a constituent element (of an event) input by the user of the terminal 300, and the individual information management unit 111 acquires a relationship link including the constituent element as a link source or a link destination from the relationship link DB 123. Further, the individual information management unit 111 acquires, from the structured ID DB 122, for example, the structured ID including the constituent element indicated by the link source or the link destination of the extracted relationship link. The individual information management unit 111 displays the acquired relationship link and the acquired structured ID on the output apparatus 106 and the terminal 300.

In the above-described example, the individual DB use and the individual DB registration are executed with the input by the user of the terminal 300 serving as a trigger, and it is also possible to implement automatically-executed push-type individual DB use and individual DB registration, for example, with transmission of information from an application to the individual information management apparatus 100 serving as a trigger without the user performing an operation actively.

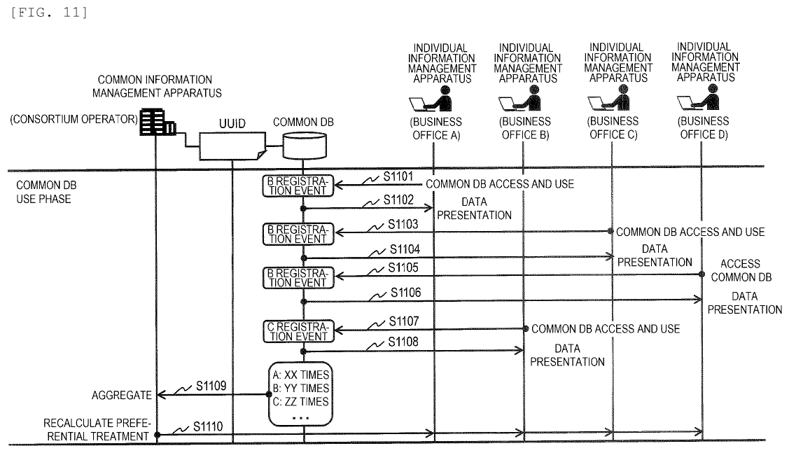

FIG. 10 shows an outline example of the push-type individual DB use processing and individual DB registration processing. In the example in FIG. 10, the relationship link in the relationship link DB 123 is defined in advance, and the structured ID in the structured ID DB 122 is not defined.

The individual information management unit 111 extracts the structured ID and the relationship link from an event indicated by information received from the terminal 300 or information indicated by information received from an application in the IT application group 800 or the OT application group 810, and registers the structured ID and the relationship link in the structured ID DB 122 and the relationship link DB 123 of the individual DB unit 120, respectively (S912).

It is assumed that the individual information management apparatus 100 receives a DCS alarm indicating that “a light failure occurs in the Machine_XX in the Line_B in the Plant_A in the System_A” from the application in the OT application group 810. At this time, the individual information management unit 111 the structured generates ID “System_A/Plant_A/Line_B/Machine_XX/light failure” by separating constituent elements of an event indicated by the DCS alarm with slashes, and registers the generated structured ID in the structured ID DB 122.

The individual information management unit 111 acquires, from the relationship link DB 123, a relationship link including a link source or a link destination that partially matches the structured ID (that is, includes a constituent element contained in the structured ID or matches a constituent element that is continuous across slashes in the structured ID). In the example in FIG. 10, the individual information management unit 111 acquires a relationship link including “Machine_XX light failure” as the link source and “Manual_A” as the link destination.

The individual information management unit 111 notifies the IT application group 800 and the OT application group 810 of “Manual_A”, which is a constituent element paired with the structured ID in the relationship link, and searches for an application that can provide information related to “Manual_A”.

In the example in FIG. 10, the application in the OT application group 810 acquires file information of “Manual_A” (the Manual_A in the Line_B in the Plant_A in the System_B) and a file of the “Manual_A” retained by the file server, and transmits the file information and the file to the individual information management apparatus 100. The individual information management unit 111 generates the structured ID of “System_B/Plant_A/Line_B/Manual_A” by separating constituent elements of an event indicated by the file information with slashes, and registers the generated structured ID in the structured ID DB 122.

The individual information management unit 111 displays the DCS alarm and the file of the manual on the terminal 300. The individual information management unit 111 may display the generated two structured IDs and the acquired relationship link on the terminal 300. By the above-described processing, the push-type individual DB use and individual DB registration are implemented.

Although the structured ID is not defined in the structured ID DB 122 in the example in FIG. 10, the structured ID generated in the example in FIG. 10 may be defined in advance in the structured ID DB 122. In this case, the above-described processing of generating the structured ID is omitted.

The push-type described using FIG. 10 can also be applied to common DB use and common DB registration to be described later by using the common structured ID: instead of the structured ID, using the common relationship link instead of the relationship link, and mediating transmission and reception of information between the common information management apparatus 200 and the application by the individual information management apparatus 100. However, in the common DB registration, even in the push-type, an examination is executed by the examination unit 212 of the common information management apparatus 200.

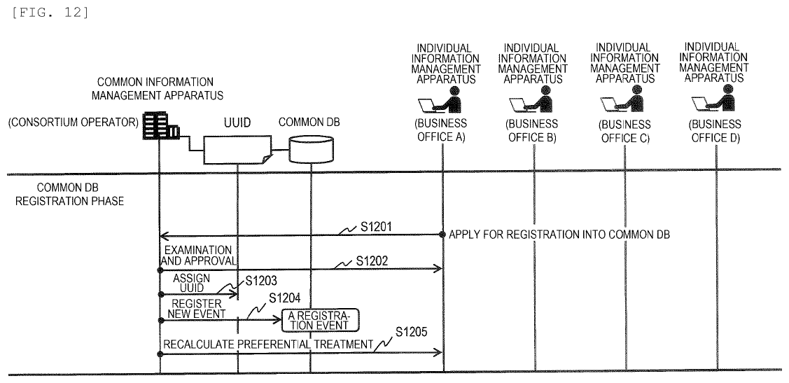

FIG. 11 is a sequence diagram showing an example of the common DB use phase. The common information access unit 116 of the individual information management apparatus 100 owned by the business office A accesses the common DB unit 220, for example, in response to a common DB use request (a common DB use request input by the user of the terminal 300) received from the terminal 300 or a common DB use request received from the IT application group 800 or the OT application group 810 (S1101).

The search unit 215 acquires the common relationship link including a constituent element (of an event) indicated by the received common DB use request from the common relationship link DB 223, acquires the common structured ID including the constituent element indicated by the acquired common relationship link from the common structured ID DB 222, and transmits the acquired common relationship link and the acquired common structured ID to the individual information management apparatus 100 owned by the business office A (S1102).

Through the processing of steps S1101 and S1102, the business office A can receive presentation of information related to the constituent element indicated by the common DB use request and registered in the common DB unit 220 by another business office. The common relationship link and the common structured ID transmitted in step S1102 are registered by the individual information management apparatus 100 owned by the business office B.

Since processing of steps S1103 to S1108 are the same as the processing of steps S1101 and S1102 except that the business office owning the individual information management apparatus 100 differs and the business office that registers data acquired from the common DB unit 220 differs, description thereof will be omitted.

The membership fee calculation rule 225 is determined such that the membership fee reduction rank can be changed according to a cumulative citation record from the common DB unit 220 of another business office. Accordingly, the membership fee calculation unit 216, for example, periodically aggregates the cumulative citation record of each business office and updates the cumulative citation record of each business office in the membership management DB 224 (S1109).

The membership fee calculation unit 216 recalculates the membership fee reduction rank and the membership fee based on the normal membership fee rank, the updated cumulative citation record, and the membership fee calculation rule 225, and stores the membership fee reduction rank and the membership fee of the business office A after the recalculation in the membership management DB 224 (S1110). The membership fee calculation unit 216 may notify the individual information management apparatus 100 of the business office A of the updated cumulative citation record, and the membership fee reduction rank and the membership fee of the business office A after the recalculation.

FIG. 12 is a sequence diagram showing an example of the common DB registration phase. In the example in FIG. 12, processing is described in which the individual information management apparatus 100 owned by the business office A registers data into the common DB unit 220, and since the same processing is also executed for each individual information management apparatus 100 owned by other business offices, illustration and description thereof are omitted.

The common information access unit 116 of the individual information management apparatus 100 owned by the business office A transmits the structured ID and/or the relationship link to the common information management apparatus 200 via the common I/F unit 114 to apply for registration into the common DB unit 220 (S1201).

In step S1201, before the structured ID and/or the relationship link is transmitted to the common information management apparatus, the individual dictionary conversion unit 113 preferably refers to the dictionary DB 121 and converts the business-office-specific term contained in the structured ID and/or the relationship link into the general term. However, the individual dictionary conversion unit 113 may transmit the structured ID and/or the relationship link to the common information management apparatus 200 without conversion, and the common dictionary conversion unit 214 may perform the conversion using the common dictionary DB 221.

In step S1201, only when the security management unit 115 determines that there is no concern in terms of security in the registration of the structured ID and/or the relationship link into the common DB unit 220, the application for the registration into the common DB unit 220 may be performed.

The examination unit 212 of the common information management apparatus 200 examines whether the received structured ID and/or the received relationship link can be registered in the common DB unit 220 (S1202). For example, the examination unit 212 performs the examination in step S1202 by displaying the received structured ID and/or the received relationship link on the output apparatus 206 and acquiring an examination result input to the input apparatus 205 by the user of the common information management apparatus 200 who checks the displayed structured ID and/or the displayed relationship link.

The examination unit 212 refers to, for example, the common structured ID DB 222 and the common relationship link DB 223, and determines whether the structured ID and/or the relationship link received from the individual information management apparatus 100 is a content to be newly registered (determines that the examination indicates approval when the content is newly registered, and determines that the examination indicates denial when the content is not newly registered), or determines whether the structured ID and/or the relationship link received from the individual information management apparatus 100 is tampered with (determines that the examination indicates approval when the structured ID and/or the relationship link is not tampered with, and determines that the examination indicates denial when the structured ID and/or the relationship link is tampered with).

When the examination unit 212 determines that the examination indicates approval, the processing proceeds to step S1203 and subsequent steps, and when the examination unit 212 determines that the examination indicates denial, the processing of the common DB registration phase is ended.

The common information registration unit 213 assigns the UUID and the business office ID indicating the business office A to each of the structured ID and/or the relationship link approved by the examination, and stores the structured ID and/or the relationship link in the common structured ID DB 222 and/or the common relationship link DB 223 (S1204).

The membership fee calculation rule 225 is determined such that the membership fee reduction rank can be changed for each business office according to the cumulative registration record of the structured ID and/or the relationship link into the common DB unit 220. Accordingly, the membership fee calculation unit 216 updates the cumulative registration record of the business office A in the membership management DB 224, recalculates the membership fee reduction rank and the membership fee based on the normal membership fee rank, the updated cumulative registration record, and the membership fee calculation rule 225, and stores the membership fee reduction rank and the membership fee of the business office A after the recalculation in the membership management DB 224 (S1205). The membership fee calculation unit 216 may notify the individual information management apparatus 100 of the business office A of the updated cumulative registration record, and the membership fee reduction rank and the membership fee of the business office A after the recalculation.

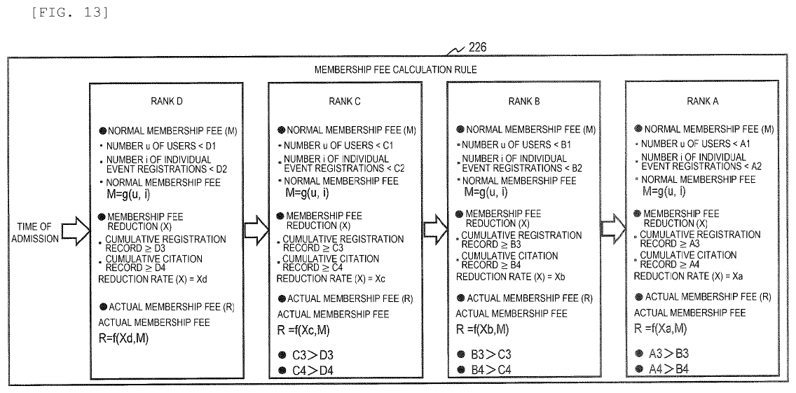

FIG. 13 is an example of the membership fee calculation rule 225. In the membership fee calculation rule 225, an actual membership fee R to be paid by the business office increases as a normal membership fee M increases, and decreases as a membership fee reduction rate X increases. Accordingly, for example, the actual membership fee R is expressed as R=f(X, M). XM obtained by multiplying the normal membership fee M by the membership fee reduction rate X is an example of f (X, M).

The normal membership fee M increases (for example, in proportion) as the number u of users who can access the common DB unit 220 in the business office and the number i of individual event registrations by the business office increase. Accordingly, for example, the normal membership fee M=g(u, i) (where g is a function of u and i). The membership fee reduction rate X is determined according to a rank defined by the membership fee calculation rule 225.

The normal membership fee rank is determined to be a lower rank as the number of users who can access the common DB unit 220 in the business office decreases and as the number of event registrations into the individual DB unit 120 (the number of registrations of the structured ID and/or the relationship link) decreases.

In the example in FIG. 13, a rank condition related to the number u of users who can access the common DB unit 220 (hereinafter, also referred to as a user condition), and a rank condition related to the cumulative registration record of the information in the common DB unit 220 and the cumulative citation record of the information registered in the common DB unit 220 (hereinafter, referred to as a common DB condition) are determined, and the rank of the membership fee reduction rate is determined based on the two rank conditions.

The rank of the user condition is D if the number u of users is less than D1, the rank of the user condition is C if the number u of users is D1 or more and less than C1, the rank of the user condition is B if the number u of users is C1 or more and less than B1, and the rank of the user condition is A if the number u of users is B1 or more and less than A1 (A1−1 is a maximum number of accessible users, and the condition may be simply B1 or more when the maximum number of users is not determined).

In the example in FIG. 13, the rank of the common DB condition is D if the cumulative registration record is D3 or more and less than C3 and the cumulative citation record is D4 or more and less than C4, the rank of the common DB condition is C if the cumulative registration record is C3 or more and less than B3 and the cumulative citation record is C4 or more and less than B4, the rank of the common DB condition is B if the cumulative registration record is B3 or more and less than A3 and the cumulative citation record is B4 or more and less than A4, and the rank of the common DB condition is A if the cumulative registration record is A3 or more and the cumulative citation record is A4 or more.

That is, as the cumulative registration record and the cumulative citation record increase, the rank of the common DB condition is better and the reduction rate increases. In the above-described example, the rank of the common DB condition is determined by an and condition of the cumulative registration record and the cumulative citation record, and alternatively, the rank of the common DB condition may be determined by an or condition (for example, a better one of ranks of the common DB condition is adopted as the rank of the common DB condition). When the rank of the user condition is different from the rank of the common DB condition, a worse rank therebetween may be adopted or a better rank therebetween may be adopted.

When the rank does not even reach the rank D, for example, there is no rank and the reduction rate is set to 0 (that is, it is set that there is no reduction). For example, the actual membership fee immediately after the business office passes the registration examination of the common DB unit 220 (that is, when all of the number u of users, the number i of individual event registrations, the individual DB, the cumulative registration record, and the cumulative citation record are 0) is R0.

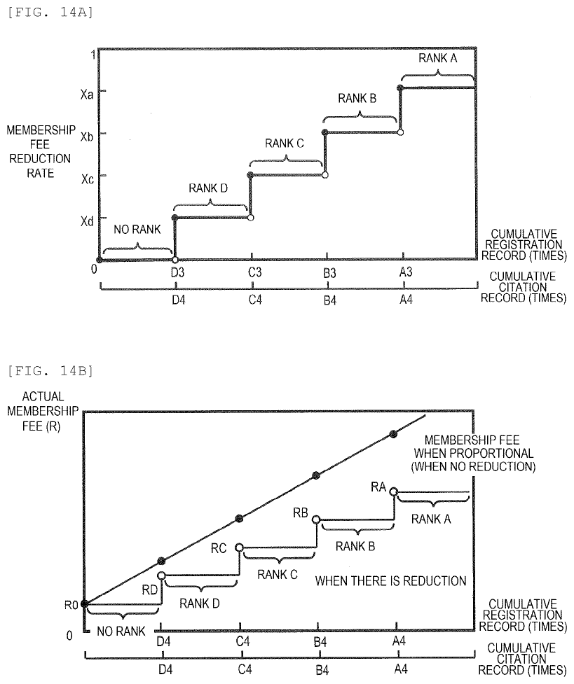

FIG. 14A is an example of a graph showing a relationship between the rank and the membership fee reduction rate X. In the example in FIG. 14A, as the cumulative registration record and the cumulative citation record increase, the rank is better and the membership fee reduction rate increases. In the example in FIG. 14A, the membership fee reduction rate increases stepwise according to the rank, and alternatively, the membership fee reduction rate may differ even at the same rank (for example, even at the same rank, the membership fee reduction rate increases as the cumulative registration record increases and as the cumulative citation record increases).

FIG. 14B is an example of a graph showing a relationship between the rank and the actual membership fee R. In the example in FIG. 14B, the actual membership fee R when it is assumed that there is no reduction increases from the initial value R0 in proportion to an increase in the number u of users and the number i of individual event registrations by the business office. In the example in FIG. 14B, at all the ranks, the actual membership fee R when reduction is received is equal to or less than the actual membership fee R when no reduction is received. In the example in FIG. 14B, the actual membership fee R when the reduction is received increases stepwise, and alternatively, the actual membership fee may differ even at the same rank.

The present invention is not limited to the above-described embodiment, and includes various modifications. For example, the embodiment described above has been described in detail to facilitate understanding of the present invention, and the present invention is not necessarily limited to those including all the described configurations. A part of a configuration in one embodiment can be replaced with a configuration in another embodiment, and a configuration in one embodiment can also be added to a configuration in another embodiment. A part of a configuration in each embodiment may be added to, deleted from, or replaced with another configuration.

A part or all of the configurations, functions, processing units, processing methods, and the like described above may be implemented by hardware by, for example, designing with an integrated circuit. Each of the above-described configurations, functions, and the like may be implemented by software by a processor interpreting and executing a program for implementing each function. Information such as a program, a table, and a file for implementing each function can be stored in a recording apparatus such as a memory, a hard disk, or a solid state drive (SSD), or in a recording medium such as an IC card, an SD card, or a DVD.

Control lines and information lines indicate what is considered to be necessary for explanation, and not necessarily all control lines and information lines are always shown on a product. Actually, it may be considered that almost all the configurations are connected to each other.

1. A consortium operation apparatus comprising:
a processor; and
a storage apparatus, wherein
the storage apparatus retains
a common database accessible by a terminal used by each of one or more business offices belonging to a consortium and
a rule for calculating a preferential treatment to be provided to each of the one or more business offices,
the common database retains information registered from the terminal, and
the processor
acquires information from the common database in response to a request from the terminal, transmits the information to the terminal to present the information to a business office owning the terminal,
aggregates a registration record of information into the common database and a presentation record of information registered in the common database for each terminal, and
provides the preferential treatment to each of the one or more business offices based on the aggregated registration record, the aggregated presentation record, and the rule.

2. The consortium operation apparatus according to claim 1, wherein
the common database stores
common dictionary information in which a business-office-specific term and a general term used by each of the one or more business offices are associated with each other,
common structured ID information indicating common structured IDs that hierarchically indicate a constituent element of an event occurring in each of the one or more business offices, and
common relationship link information indicating a common relationship link indicating that there is a relationship between the common structured IDs.

3. The consortium operation apparatus according to claim 2, wherein
the processor
acquires, from the common relationship link information, a common relationship link including a constituent element of an event indicated by the request from the terminal,
acquires, from the common structured ID information, structured ID linked in the acquired common a common relationship link, and
transmits, to the terminal, the acquired common relationship link and the acquired common structured ID information.

4. The consortium operation apparatus according to claim 2, wherein
the processor
executes conversion processing of converting a general term contained in the information acquired from the common database into a business-office-specific term of the business office owning the terminal with reference to the common dictionary information, and
transmits, to the terminal, the information subjected to the conversion processing.

5. The consortium operation apparatus according to claim 2, wherein
each of the common structured IDs in the common structured ID information is provided with an identifier for ensuring uniqueness using predetermined encryption processing.

6. The consortium operation apparatus according to claim 2, wherein
each of the common structured IDs is generated from information obtained from an application used by the one or more business offices.

7. The consortium operation apparatus according to claim 1, wherein
the preferential treatment is reduction of a membership fee to be paid to an operator of the consortium by each of the one or more business offices, and
the rule is determined such that a reduction rate of the membership fee increases as the aggregated registration record and the aggregated presentation record increase.

8. The consortium operation apparatus according to claim 7, wherein
the storage apparatus
retains an individual database for each of the one or more business offices, the individual database being accessible only by the own business office, and
determines the rule such that the membership fee increases as the number of individual event registrations into the individual database and the number of users accessible to the common database increase.

9. A consortium operation method performed by a consortium operation apparatus, wherein
the consortium operation apparatus retains
a common database accessible by a terminal used by each of one or more business offices belonging to a consortium and
a rule for calculating a preferential treatment to be provided to each of the one or more business offices,
the common database retains information registered from each of the terminals, and
the consortium operation method comprises:
causing the consortium operation apparatus to acquire information from the common database in response to a request from each of the terminals, transmit the information to the terminal to present the information to a business office owning the terminal;
causing the consortium operation apparatus to aggregate a registration record of information into the common database and a presentation record of information registered in the common database for each terminal; and
causing the consortium operation apparatus to provide the preferential treatment to each of the one or more business offices based on the aggregated registration record, the aggregated presentation record, and the rule.
